(19) United States
(12) Patent Application Publication
(10) Pub. No.: US 2009/0099971 A1
(43) Pub. Date: Apr. 16, 2009

(54) Methods and systems for marketing distressed inventory

(75) Inventors: Joseph Salemme, Shelton, CT (US); Gary W. Hare, Shelton, CT (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Oneway LLC.

(21) Appl. No.: 12/285,601

(22) Filed: Oct. 9, 2008

Related U.S. Application Data
(60) Provisional application No. 60/978,892, filed on Oct. 10, 2007.

(51) Int. Cl. G06Q 30/00; G06Q 50/00; G06Q 20/00

(52) U.S. Cl. 705/80; 705/26; 705/5

(57) ABSTRACT

Methods and systems are disclosed for marketing distressed inventory. In one aspect, a method is disclosed for marketing distressed inventory that may be performed by a distressed inventory system. The method may include receiving distressed inventory data from at least one supplier reflecting available distressed inventory and receiving a request from a client. Moreover, the method may include determining a relationship between the request and the available distressed inventory and notifying the client of the available distressed inventory. Further, the method may include receiving an indication that the client has accepted one or more terms for receiving the available distressed inventory, and reserving the available distressed inventory for the client.

### RELATED APPLICATION

This application claims priority to U.S. Provisional Patent Application No. 60/978,892 filed on Oct. 10, 2007, entitled ONLINE DISTRESSED INVENTORY MARKETING SYSTEM FOR TRANSPORTATION AND LOGISTICS SERVICES, and is herein incorporated by reference in its entirety.

### BACKGROUND

This application relates to electronic commerce, and in particular to methods and systems for marketing distressed inventory via a network.

The supply industry thrives on its ability to provide products or services where needed. Accordingly, the success of a supplying organization depends on its ability to identify a need for its products or services, and fill that need before its competitors. While supplier organizations invest heavily to target promising markets, some are unable to identify opportunities before they are taken. For example, suppliers in the livery industry, such as transportation, trucking, and logistics organizations, continue to experience lost revenue as a result of unused segments of customer trips (e.g., a limousine returning to its home base location empty after dropping a customer at a destination). These unused segments represent significant losses to supplying organizations.

In an attempt to avoid missed opportunities, some supplying organizations leverage the Internet to identify and attract customers. Although there are a number of online reservations systems currently serving the livery industry, most are simply broker systems (e.g., sending an email to a limousine company in exchange for a fee) or directories (e.g., yellow pages), and do not address unused segments or other types of distressed inventories.

Accordingly, there is a need for a system and method that allows a supplying organization to market its distressed inventory to potential consumers and provide access to an environment for those consumers to search for, reserve, and pay for the unused segments.

### SUMMARY OF THE INVENTION

To address the problems facing the supplying industry, methods and systems are disclosed that provide consumers access to unused segments. In one embodiment, a method is disclosed for marketing distressed inventory that may be performed by a distressed inventory system. The method may include receiving distressed inventory data from at least one supplier reflecting available distressed inventory and receiving a request from a client. Moreover, the method may include determining a relationship between the request and the available distressed inventory and notifying the client of the available distressed inventory. Further, the method may include receiving an indication that the client has accepted one or more terms for receiving the available distressed inventory, and reserving the available distressed inventory for the client.

In another embodiment, a distressed inventory system is discloses that includes a computer system and at least one memory including software processes executed by the computer system. The software processes may be configured to receive distressed inventory data from at least one supplier reflecting available distressed inventory and receive a request from a client. The software processes may also determine a relationship between the request and the available distressed inventory and notify the client of the available distressed inventory. Moreover, the software processes may receive an indication that the client has accepted an agreement to receive the available distressed inventory in exchange for payment of funds and reserve the available distressed inventory for the client after receiving payment and before a consumer associated with the client receives the available distressed inventory.

In another embodiment, a system for marketing transportation services is disclosed that may include a network and a computer system connected to the network. The computer system may be configured to provide a Web site that presents data representing a set of available unused travel segments, wherein each available unused travel segment is associated with at least one transportation supplier. The computer system may also receive, via input from a consumer to the Web site, a request for travel from a first location to a first destination. The computer system may determine a relationship between the request and at least one of the available unused travel segments based on a comparison of the request and at least one of a characteristic of the available unused travel segments and the transportation supplier. Additionally, the computer system may be configured to provide a list of unused travel segments to the Web site including the at least one available unused travel segments and receive, via input from the consumer to the Web site, a selection of the at least one available unused travel segment. The computer system may also determine a price for the at least one available unused travel segment and determine that a first payment of the price has been received. Also, the computer system may provide a second payment to the transportation supplier associated with the selected at least one available unused travel segment. In one embodiment, the second payment is less than the first payment.

In another embodiment, a method for marketing transportation services is disclosed that may include providing a Web site that includes data reflecting a set of available unused segments of transportation service suppliers. The method may also include providing through the Web site, a mechanism for a user to input a request for transportation, wherein the request includes at least one parameter including at least one of a type of vehicle parameter, a number of passengers parameter, a passenger airline flight information parameter, a pick up time parameter, a destination parameter, and a pick up location parameter. Further, the method may include presenting through the Web site a set of available unused segments include at least one parameter that matches the at least one parameter of the request and receiving through the Web site a selection of a first one of the available unused segments. The method may also include receiving payment for the selected first available unused segment and presenting a confirmation of a reservation for the user to receive the first available unused segment.

### BRIEF DESCRIPTION OF THE DRAWINGS

FIG. 1 is a block diagram of a distressed inventory marketing system consistent with embodiments of the present invention;

FIG. 2 is a flowchart of an exemplary distressed inventory process consistent with embodiments of the present invention;

FIGS. 3-8 are flowcharts of another exemplary distressed inventory process consistent with embodiments of the present invention;

FIG. 9 is a flowchart of an exemplary distressed inventory search process consistent with embodiments of the present invention;

FIG. 10 is a flowchart of an exemplary distressed inventory pricing process consistent with embodiments of the present invention; and

FIG. 11 is a flowchart of an exemplary distressed inventory allocation process consistent with embodiments of the present invention.

### DETAILED DESCRIPTION

Reference will now be made in detail to exemplary aspects of the present invention, examples of which are illustrated in the accompanying drawings. Wherever possible, the same reference numbers will be used throughout the drawings to refer to the same or like parts.

Methods and systems consistent with the certain embodiments provide supplier companies with an network accessible (e.g., Internet via computer, cell phone, land line phone, or personal digital assistant (PDA)) online environment for posting distressed or unused inventory (e.g., empty segments) for sale to consumers months, weeks, days, and minutes after they become available. Methods and systems consistent with certain disclosed embodiments also provide consumers with a network accessible online environment for providing requirements for inventory, such as a request for a limousine ride identifying a consumer pickup time, location, airline flight arrival time, etc.

In one embodiment, a distressed inventory marketing system and method is disclosed that performs a programmable search process that matches the empty segments of supplier companies (e.g., limousine companies) with the requirements of consumers (e.g., trip requirements). These embodiments provide an environment for offering and selling distressed inventory (e.g., unused segments for limousine trips), and thus creates a marketplace for commerce between suppliers and consumers. Moreover, the distressed inventory system and method provides pricing processes that consider different factors related to the requested requirements to price distressed inventory, such as the type of vehicle and distance requested by a limousine consumer. Also, the distressed inventory system and methods may provide an allocation process that manages the fair allocation of distressed inventory from participating suppliers (e.g., equally allocate trip requests between different limousine companies to prevent one company from monopolizing the business). For example, in one embodiment, the allocation process may award consumer reservations to limousine companies on a rotating basis.

Thus, in certain embodiments, the distressed inventory marketing system and method provide an online mechanism for a consumer to select and possibly obtain distressed inventory. The system and methods may secure a reservation with a selected supplier based on the consumer's selection and provide both the supplier and consumer with each others contact information for confirmation of delivery (e.g., a limousine company confirming pick up time and place with a consumer). In one embodiment, the disclosed systems and methods execute payment in advance from the consumer, and upon successful delivery of the inventory to the consumer (e.g., successful pickup and drop off of a limousine consumer), provide payment to the supplier, less commissions and fees if so arranged.

The disclosed embodiments may implement program instructions or program code stored on computer readable media storage device for performing various computer-implemented operations consistent with certain aspects of marketing distressed inventory. The program instructions or code may be specially designed and constructed for the purposes of the disclosed embodiments, or they may be of the kind well-known and available to those having skill in the computer software arts. Examples of program instructions and code include, for instance, application software, machine code, such as produced by a compiler, files containing a high level code that can be executed by the computer using an interpreter, and any other type of computer instruction that may be executed by a processor, or program logic.

The storage device referred to herein may reflect elements that temporarily or permanently store data and instructions. The storage functions associated with the disclosed embodiments may be implemented via a computer, portions of a computer, a processor, a computer network, and any other component and medium capable of storing information. For example, various types of storage device may be used to store information associated with the embodiments of the present invention, such as read-only memory (ROM), random access memory (RAM), and any other type of memory. Further, the storage functions associated with the disclosed embodiments may be physically implemented by computer-readable media storage device, such as, for example (a) magnetic media (e.g., a magnetic disk, a tape drive, etc.; (b) optical media, (e.g., a CD-ROM, digital versatile disk (DVD), a mini-disc, etc.); and (c) semiconductor or other media (e.g., DRAM, SRAM, EPROM, EEPROM, flash memory, etc.). In one embodiment, distressed inventory system 110 may include one or more memory devices that store algorithms that, when executed by a processor, perform functions related to marketing distressed inventory. For example, a distressed inventory system is disclosed that may include a search program that, when executed by a processor, performs a search algorithm for assisting a user of client 130 to identify available distressed inventory. The distressed inventory system may also include a pricing program that, when executed by a processor, performs a pricing algorithm for providing a user with different pricing option for obtaining available distressed inventory. Further, the distressed inventory system may include an allocation program that, when executed by a processor, performs an allocation process for allocating one or more supplier's distressed inventory for consideration by the user.

Further, the disclosed embodiments may be implemented using various types of communication protocols and data formats, such as, for example, transmission control protocol/internet protocol (TCP/IP), hyper text transfer protocol (HTTP), secure HTTP, wireless application protocol (WAP), hyper text markup language (HTML), extensible markup language (XML), Standard Generalized Markup Language (SGML), etc.

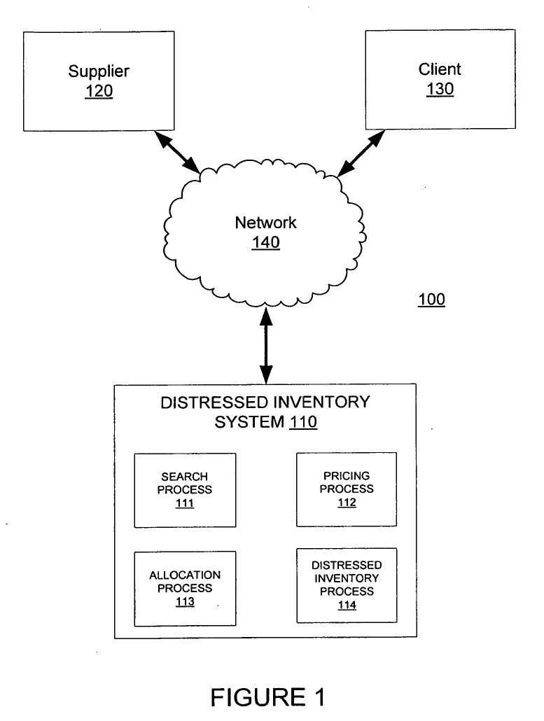

FIG. 1 illustrates an exemplary distressed inventory marketing system 100 consistent with disclosed embodiments of the present invention. As shown in FIG. 1, system 100 includes a distressed inventory system 110, a supplier 120, a client 130, and network 140. Distressed inventory system 110 may be a computer system that includes computing components that execute software to provide one or more functions consistent with the disclosed embodiments. For instance, distressed inventory system 110 may include one or more computers configured to receive requests for information or services over network 140 and provide information over network 140. For example, in one embodiment, distressed inventory system 110 may include one or more computer or data processing devices that have hardware (e.g., processors, storage memory, data buses, network interface, etc.), software (e.g., application programs, operating systems, other executable program code written in any known programming language such as C, C++, Java™, etc.), and/or firmware (e.g., software embedded in a hardware device) that provide access to information stored in memory. Distressed inventory system 110 may include, or communicate with, a Web server that provides one or more Web sites that receive requests for information and provides information to supplier 120 and client 130 over network 140. In other embodiments, distressed inventory system 110 may be configured with a Web server that operates with one or more Web sites that include one or more Web pages provided from another component of system 100, and provides the received Web pages to supplier 120 and/or client 130. In certain embodiments, distressed inventory system 110 may use software, algorithms, web rendering logic, data, etc. that may reside in external systems. For instance, distressed inventory system 110 may be configured to receive requests related to distressed inventory via network 140, forward the requests to another computer system, and receive information from the other computer system. Moreover, distressed inventory system 110 may include one or more processors that execute one or more processes for marketing distressed inventory from supplier 120 to client 130. For instance, distressed inventory system 110 may include one or more memory devices that store a search process 111, a pricing process 112, and an allocation process 113 that, when executed by a processor, perform functions consistent with certain disclosed embodiments. Additionally, distressed inventory system 110 may include a distressed inventory process that, when executed by a processor, perform one or more processes for marketing and offering distressed inventory via network 140. Also, additional processes may be included in distressed inventory system 110 that enable marketing of distressed inventory consistent with the disclosed embodiments.

In one embodiment, distressed inventory system 110 may be associated with a business entity that operates components of system 110 to market distressed inventory to suppliers 120 and consumers associated with respective clients 130. The distressed inventory business entity may include, among other things, infrastructure, processes, personnel, etc. necessary to operate a business and to contract with other entities, such as individuals or business organizations (e.g., a consumer, supplier, etc.).

Supplier 120 may be one or more computer systems configured to send requests for information (e.g., reservation confirmations, registration information, available distressed inventory, etc.) and receive information via network 140. For example, supplier 120 may include a desktop PC, a laptop PC, a PDA, a cell phone device, or any other processor, computer, or device (or group thereof) capable of requesting and receiving information over network 140, such as the Internet. In one embodiment, supplier 120 may include one or more computer or data processing devices that have hardware (e.g., one or more processors, storage memory, data buses, network interface, etc.), software (e.g., web browsers, application programs, operating systems, other executable program code written in any known programming language such as XML, JavaScript™, C, C++, Java™, etc.), and/or firmware (e.g., software embedded in a hardware device). Supplier 120 may be configured to access one or more Web pages at one or more Web sites maintained on one or more server computer systems over network 140, such as Web pages provided by, or associated with, distressed inventory system 110. A user may operate supplier 120 to perform functions consistent with certain embodiments of the disclosed invention. Further, in certain embodiments, supplier 120 may access one or more external computer systems (e.g., distressed inventory system 110) via network 140. Although FIG. 1 shows one supplier 120, the disclosed embodiments are not limited to such a configuration. Indeed, supplier 120 may represent one or more suppliers, each configured similar to supplier 120, as described above. In one embodiment, supplier 120 represents a set of different computer systems operated by respective limousine companies that have available distressed inventory to market. For example, supplier 120 may represent a dispatcher or driver for a limousine company that accesses the Internet to access a Web site associated with distressed inventory system 110.

In one embodiment, supplier 120 may be associated with a business entity that operates the components of supplier 120 to market distressed inventory to consumers via distressed inventory system 110 or through other means. The supplier business entity may include, among other things, infrastructure, processes, personnel, etc. necessary to operate a business and to contract with other entities, such as individuals or business organizations (e.g., distressed inventory business entity, consumers, suppliers, etc.).

Client 130 may be one or more computer systems configured to send requests for information (e.g., content, application, data, program code, etc.) and receive information via network 140. For example, client 130 may be a desktop PC, a laptop PC, a PDA, a cell phone devices, or any other processor, computer, or device (or group thereof) capable of requesting and receiving information over a network, such as the Internet. In one embodiment, client 130 may include one or more computer or data processing devices that have hardware (e.g., one or more processors, storage memory, data buses, network interface, etc.), software (e.g., Web browsers, application programs, operating systems, other executable program code written in any known programming language such as XML, JavaScript™, C, C++, Java™, etc.), and/or firmware (e.g., software embedded in a hardware device). In one embodiment, client 130 is operated by a user who represents a consumer of distressed inventory offered by supplier 120. For example, client 130 may access a Web site associated with distressed inventory system 110 over the Internet to request, reserve, and pay for available distressed inventory. Although FIG. 1 shows a single client 130, the disclosed embodiments are not limited to such a configuration. Indeed, client 130 may represent one or more clients, each configured similar to client 130, as described above. In one embodiment, client 130 represents a computer system operated by a consumer of unused trip segments of limousine companies (e.g., supplier 120).

In one embodiment, client 130 may be associated with an entity that operates components of client 130 to search, review, and request distressed inventory from supplier 120 via distressed inventory system 110. The client entity may include, among other things, an individual consumer, a business entity that may include infrastructure, processes, personnel, etc. necessary to operate a business, or other type of entity that is capable of contracting with other entities, such as individuals or business organizations (e.g., distressed inventory business entity, supplier, etc.). Moreover, in certain embodiments, client 130 may also be a supplier of goods or services, and distressed inventory.

Network 140 may be any type of communication network configured to transmit information between distributed components of system 100. Network 140 may be a wireless and/or wireline network including one or more components (e.g., hardware, software, and/or firmware) configured to receive, route, translate, and deliver information. For example, network 140 may be the Internet, an extranet, and Intranet, a Local Area Network, etc. and include infrastructure that implements the communication of information over these types of networks, such as wireless/wireline base stations, transceivers, and related technology.

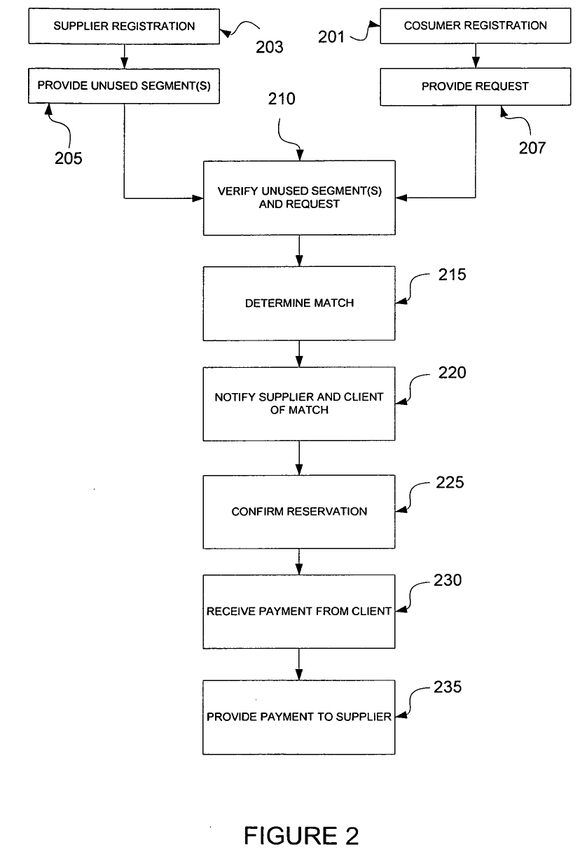

As explained, distressed inventory system 110 may include computer system components and software that when executed perform processes for marketing distressed inventory between suppliers (e.g., supplier 120) and consumers (e.g., client 130). FIG. 2 shows a flowchart of an exemplary distressed inventory process that may be performed by system 100 consistent with the disclosed embodiments. The following disclosed embodiments related to FIG. 2 are described in connection with a business example involving limousine companies who have available unused trip segments as distressed inventory and consumers who require a ride to destination (e.g., a ride from an airport after arrival). The disclosed embodiments of the present invention are not limited to such applications. Indeed, one of ordinary skill in the art would understand that distressed inventory may include any type of product or service that has an unused segment or component available for marketing to potential consumers.

Distressed inventory system 110 may provide an environment via network 140 to enable supplier 120 and client 130 to provide their requests and opportunities. In one aspect, client 130 may register with distressed inventory system 110 for future use in requesting and obtaining distressed inventory (step 201). Further, supplier 120 may also register with distressed inventory system 110 to allow it to be included in the marketing of its distressed inventory (Step 203.)

In one embodiment, supplier 120 and client 130 may each register online over the Internet by accessing one or more Web sites associated with distressed inventory system 110. Alternatively, supplier 120 and/or client 130 may each use email or other means of communicating to provide registration information to distressed inventory system 110. Further, supplier 120 and/or client 130 may contact distressed inventory system 120 using a telephone or cell phone to discuss registration with a representative associated with distressed inventory system 110.

In one embodiment, supplier 120 may register by providing information on available services as well as company information. For example, a limousine company may provide its company description and identification, the type of vehicles offered, the names of drivers, dispatchers, or other contact personnel, rates, company and/or driver history information (e.g., consumer complaints, accolades, police reports, accident history, etc.). Moreover, supplier 120 may negotiate or provide business terms and conditions with distressed inventory system 110. For instance, supplier 120 may contract with system 110 via a Web site the terms and conditions for marketing supplier 120's unused segments to potential consumers, such as fees and commissions charged by distressed inventory system 110.

In another embodiment, client 130 may register with distressed inventory system 110 by providing contact information, identification information, personal preferences (e.g., vehicle type, favorite supplier(s), etc.). Moreover, client 130 may configure privacy and business terms and conditions with distressed inventory system 110 via network 140. Client 130 may also receive during registration, or other times, a telephone number(s) to contact a representative of distressed inventory system 110 (e.g., 1-800 numbers, etc.).

In step 205, supplier 120 may provide information regarding its available unused segments (e.g., distressed inventory) to distressed inventory system 110. Similarly, in step 207, client 130 provides one or more requirements for a unused trip segment. In one embodiment, to provide information to system 110, supplier 120 and/or client 130 may each access distressed inventory system 110 via the Internet, telephone, facsimile, or the like. For instance, supplier 120 and client 130 may each access a Web site(s) provided by distressed inventory system 110 to provide data for available unused trip segments and requirements, respectively. Alternatively, supplier 120 and/or client 130 may respectively send unused segment data and requirements to distressed inventory system 110 via email or other form of electronic communication.

In providing its unused segments, supplier 120 may identify vehicle type, location, vehicle identification information, driver identification information, company identification, and any other information that distressed inventory system 110 may use to process unused segments for supplier 120. Client 130 may provide in its requirements information reflecting expected pickup time frame, airline, train, bus information, to distressed inventory system 110 via a Web site, email, telephone, facsimile, etc.

In step 210, distressed inventory system 110 verifies the unused segment and requirements information from supplier 120 and client 130. Moreover, distressed inventory system 110 may create and confirm a new business relationship between a limousine company (e.g., supplier 120) and a consumer (e.g., client 130). Thus, in step 215, distressed inventory system 110 may perform a process to determine a match between a consumer trip requirements and a limousine company unused segments. Once a match is determined, distressed inventory system 110 notifies a selected limousine company (e.g., supplier 120) and consumer (e.g., client 120) of the match (step 220). Further, distressed inventory system 110 confirms the reservation between the two parties by facilitating communications between the supplier 120 and client 130 and receives confirmation from one or both (step 225). In one embodiment, distressed inventory system 110 may notify and confirm the reservation by providing data through a Web site accessed by supplier 120 and client 130. Alternatively, distressed inventory system 110 may send an email, text message, voicemail, etc. to supplier 120 and client 130 informing them of the match.

Distressed inventory system 110 may also provide supplier 120 with contact information for client 130 and provide client 130 with contact information for supplier 120. In this way, both supplier 120 and client 130 may contact each other to confirm the reservation details, such as pickup location, times etc. In one embodiment, distressed inventory system 110 may provide an environment to facilitate the communications between supplier 120 and client 130, such as a message board via a Web site over the Internet.

Once a reservation is arranged or confirmed, distressed inventory system 110 may then request and receive payment from client 130 for the reserved unused trip segment awarded to client 130. (step 230). Distressed inventory system 110 may receive payment electronically or by other mechanisms. For instance, client 130 may provide payment to distressed inventory system 110 via credit card, online payment services, or other means for providing payment, including but not limited to the Internet, facsimile systems, email, or the like. For example, in one embodiment, distressed inventory system 110 may request a partial payment for the distressed inventory from the consumer and request the remaining fees at a later time, such as when a limousine ride consumer is picked up or delivered to a destination.

After payment is received from client 130, distressed inventory system 110 may provide a payment to supplier 120 after providing distressed inventory to client 120 (step 235). In one embodiment, distressed inventory system 110 may provide payment electronically or by other mechanisms. For instance, distressed inventory system 110 may provide payment to supplier 120 via credit card, online payment services, or other means for providing payment over network 140, including but not limited to the Internet, facsimile systems, email, or the like. Moreover, distressed inventory system 110 may provide payment to supplier 120 after it receives notification and/or confirmation that client 120 received the distressed inventory from supplier 120 (e.g., limousine company provides ride to consumer to requested destination). Further, distressed inventory system 110 may determine the amount of payment for supplier 120 based on the received payment from client 120. For example, distressed inventory system 110 may determine fees and commissions as a percentage of the payment received from client 130. Other methods and mechanisms may be implemented for receiving, determining, and/or providing payments that are consistent with the disclosed embodiments.

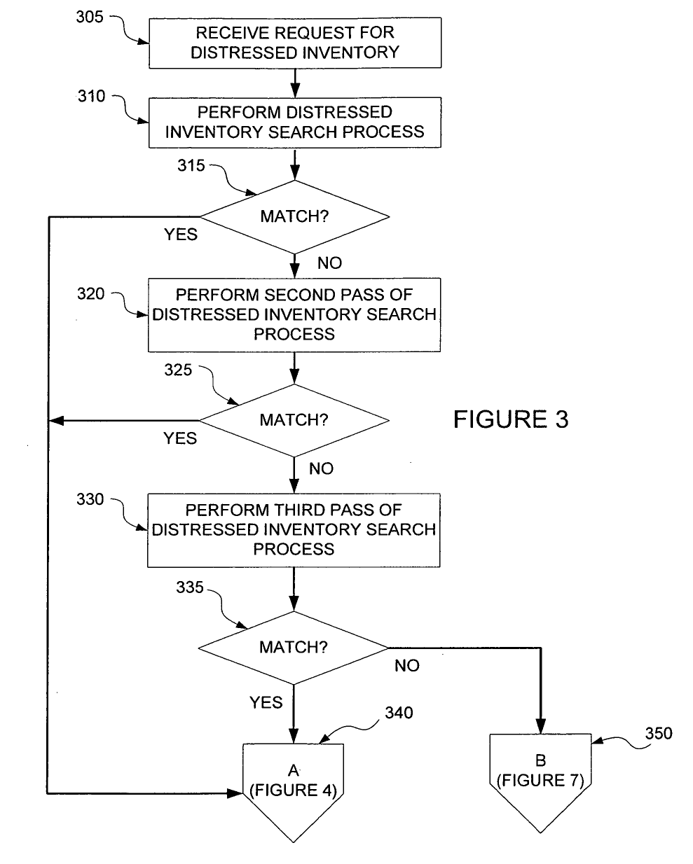

FIGS. 3-8 show flowcharts of an exemplary distressed inventory process that may be performed by distressed inventory system 110 consistent with embodiments of the present invention. In certain embodiments, distressed inventory system 110 includes software that, when executed by a processor, may perform one or more of the processes disclosed in FIGS. 3-8. The software is programmable and include business rules and workflows that may be adjusted. Accordingly, the processes described in FIGS. 3-8 are exemplary and are not intended to be limiting to the disclosed embodiments. The sequence of steps or types of functions of one or more of the processes disclosed in FIGS. 3-8 may vary or be removed, and additional processes may be added.

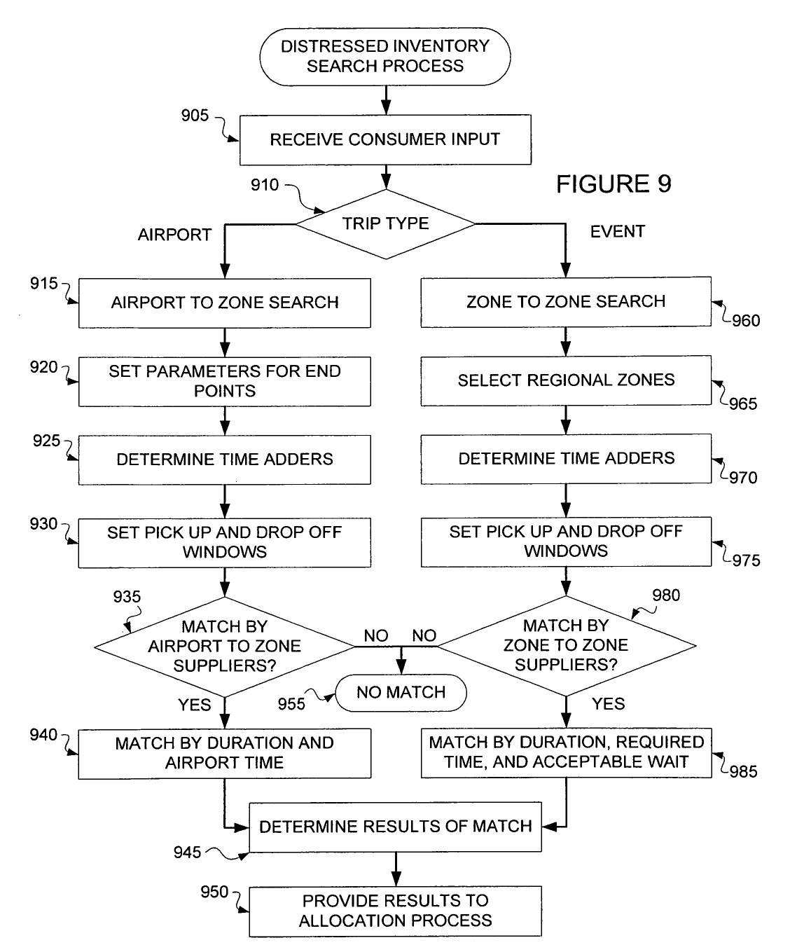

In one embodiment, a consumer operating client 130 may have a need for distressed inventory (e.g., a limousine ride). Accordingly, client 130 may generate and send a request for distressed inventory to distressed inventory system 110 (step 305). The request may include the consumer's contact information and identification, the type of distressed inventory sought (e.g., limousine ride from airport), location of consumer, travel information (e.g., flight data, arrival time, expected delays, etc.), preferences (e.g., vehicle type, driver name, company name, type of transportation, etc.), and any other information that may be included for configuring a request for distressed inventory for a consumer. Once received, distressed inventory system 110 performs a distressed inventory search process (step 310). The search process attempts to locate a supplier match for the consumer's request from client 130. In one embodiment, the search process may review all inventory that serves a particular location associated with the consumer's request. Based on that review, the search process may review a first determined number of suppliers from an allocation ranking to find a match. For instance, the search process may review the first ten suppliers from a particular list of ranked suppliers to determine if one or more can provide the requested distressed inventory. An example of the distressed inventory search process is described below in connection with FIG. 9.

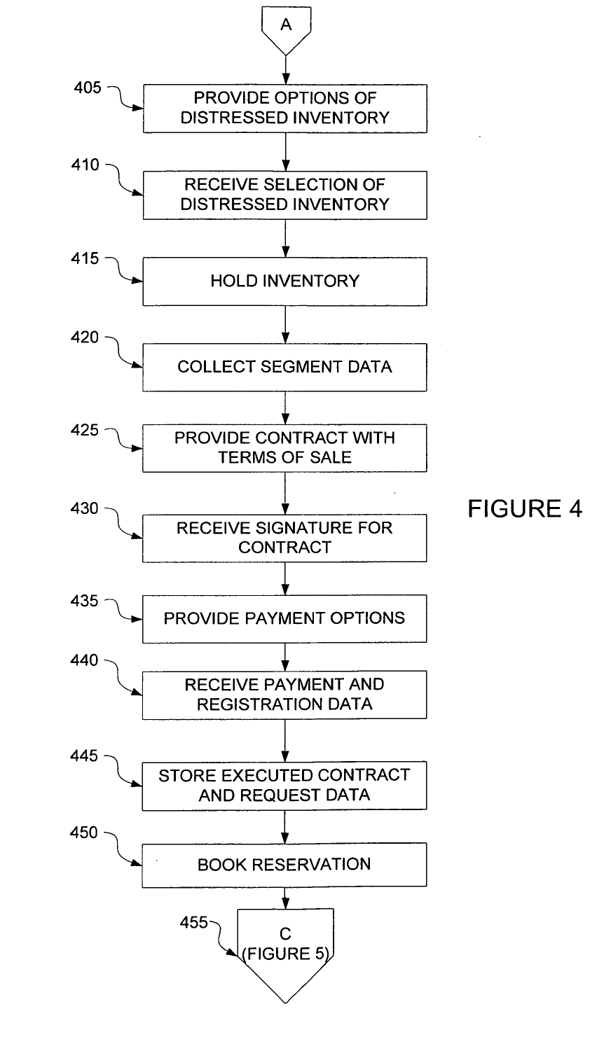

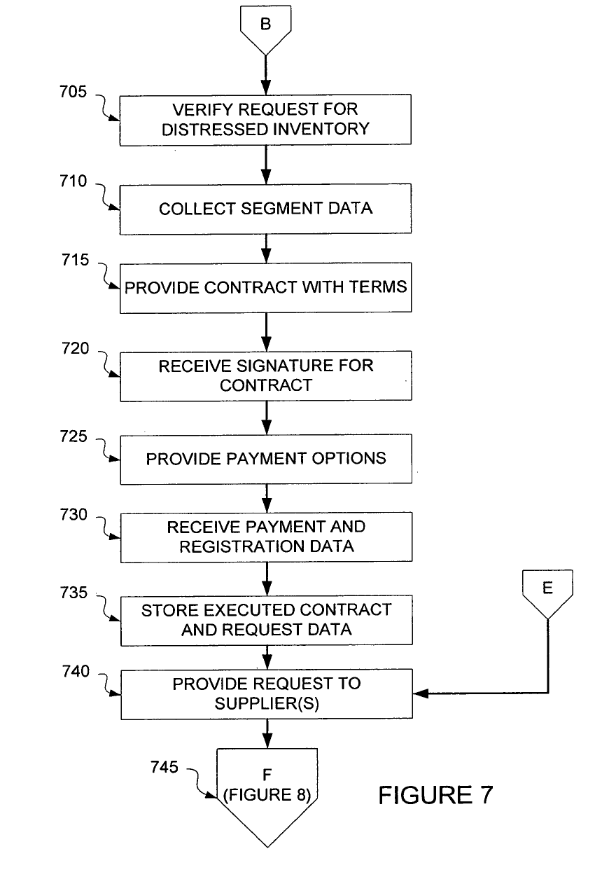

In one embodiment, distressed inventory system 110 determines whether the search process found a match for the consumer's request (step-315). If a match is found (step 315; Yes), the process continues to reference A, shown in FIG. 4 (step 340). However, if a match is not found (step 315; No), distressed inventory system 110 performs a second pass of the inventory search process, this time reviewing a next determined number of suppliers included in an allocation ranking list (step 320). For example, distressed inventory system 110 may consider the next ten suppliers if the first ten did not result in a match. If a match is found (step 325; Yes), the process continues to reference A, shown in FIG. 4 (step 340). However, if no match is found, distressed inventory system 110 performs a third pass of the inventory search process. (step 330). In the third pass, the search process may consider a next determined number of suppliers included in an allocation ranking (e.g., look at the next ten suppliers if the first twenty did not result in a match). It should be noted that the inventory search process may perform one or more passes to identify a possible supplier of the requested distressed inventory. Thus, the three pass approach of FIG. 3 is exemplary and not limiting to the disclosed embodiments. If a match is found (step 335; Yes), the process continues to FIG. 4 (step 340). If no match is found (step 335; No), the process continues to step 740 of FIG. 7, described below (step 350).

As shown in FIG. 4, if the distressed inventory search process identifies a match, distressed inventory system 110 may generate and provide options of distressed inventory to client 130 for display to the consumer (step 405). Client 130 may display the options through a Web browser or the interface software. In one embodiment, client 130 may display the options in any form for display to the consumer, such as a graph, table, chart, menu, hyperlink reference, etc. In one embodiment, the options provided to client 130 may include certain information, while not including other information. For example, distressed inventory system 110 may provide vehicle type, available pickup times, and vehicle description information to client 130, but may not include the name of the supplier offering such services. However, distressed inventory system 110 may also be configured to provide such information for display to a consumer.

At some point, distressed inventory system 110 may receive a consumer's selection of distressed inventory from client 130 (step 410). In response, distressed inventory system 110 may perform a process to hold the selected inventory to ensure no other consumers request and/or reserve the same distressed inventory (step 415). In one embodiment, distressed inventory system 110 may also request and collect data related to a requested unused segment from client 130. (Step 420). For instance, client 130 may provide distressed inventory system 110 with information related to a consumer's location, flight information, contact data, etc.

Distressed inventory system 110 may also generate a contract representing an agreement between the consumer and the business entity/individual associated with distressed inventory system 110 for receiving the distressed inventory (step 425). In one embodiment, distressed inventory system 110 may determine and provide, via network 140 or other means, the terms and conditions for the contract, such as fees, delivery requirements, and other contract terms. In response to receiving the contract, and if agreeable, the consumer may execute the contract by providing a signature to distressed inventory system 110 (step 430). For example, distressed inventory system 110 may provide a mechanism for the consumer to electronically sign the contract via client 130. For example, client 130 may access a Web site provided by distressed inventory system 110 that provides the contract in electronic form and enables the consumer through client 130 to electronically sign the document. Other mechanisms for executing the contract may also be implemented without departing from the scope of the disclosed embodiments. For example, client 130 may allow the consumer to email, send by facsimile, or use other forms of communications to provide the signed contract to distressed inventory system 110.

Distressed inventory system 110 may also determine and provide payment options to client 130 for the requested distressed inventory (step 435). In one embodiment, distressed inventory system 110 may provide the options in a Web page accessed by client 130. Alternatively, distressed inventory system 110 may provide the payment options to client 130 through other mediums and mechanisms, such as email, text messaging, telephone, etc. In response, the consumer may select a payment option and provide payment and registration data to distressed inventory system 110 through client 130 or other means (step 440). For example, distressed inventory system 110 may provide mechanisms for a consumer to provide the payment electronically, such as through credit card transactions, financial account funds transfer, etc. In one embodiment, distressed inventory system 110 may generate and maintain an account for the consumer including a balance of funds that may be used to pay for requested distressed inventory. The consumer may configure the account when, for example, registering with distressed inventory system 110, or at some other time. See e.g., step 201 of FIG. 2.

Once created, distressed inventory system 110 may store the contract and related request information in memory (step 445). Afterwards, distressed inventory system 110 performs a reservation booking process that contacts the supplier of the selected distressed inventory to confirm the inventory is available and will be provided to the consumer as requested (step 450).

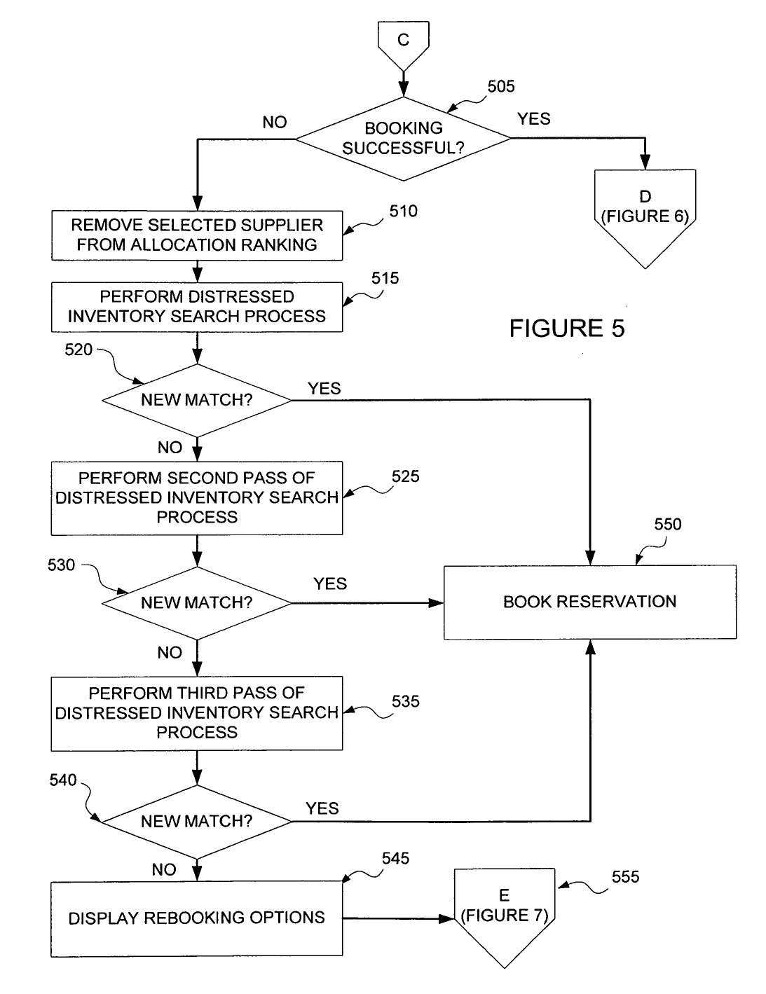

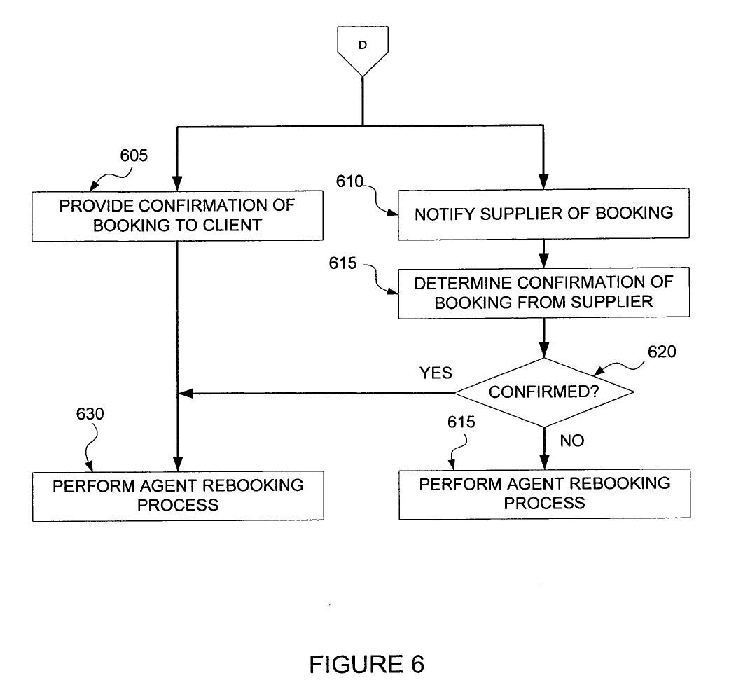

If the booking is successful (FIG. 5, step 505; Yes), the process continues to FIG. 6. However, if distressed inventory system 110 cannot successfully book the reservation with the supplier (step 505; No), it removes the selected supplier from an allocation ranking to prevent that supplier from consideration by other suppliers for the distressed inventory that supplier offered through distressed inventory system 110 (step 510). Distressed inventory system 110 then re-executes the distressed inventory search process described above in connection with steps 310 to 335 of FIG. 3, but this time without considering the supplier removed in step 510. For instance, the inventory search process may search for a supplier match with the remaining allocated suppliers included in the first determined number of suppliers included in the allocation ranking considered in step 310 of FIG. 3. Thus, for example, if in step 310, the inventory search process previously considered the first ten suppliers in an allocation ranked list, the process may in step 510 consider the remaining nine suppliers in that ranked list after removing the selected supplier who did not allow the consumer to reserve the requested inventory.

If a new supplier match is not identified in the first pass of the inventory search process (step 520; No), the process performs a second pass considering the next determined number of suppliers in the allocation ranking (e.g., the next ten suppliers) (step 525). If the process cannot identify a supplier match in the second pass (step 530; No), the inventory search process performs a third pass considering the next determined number of suppliers in the allocation ranking (e.g., the next ten suppliers) (step 525). It should be noted that the inventory search process may perform any number of passes to identify a new supplier of the requested distressed inventory. Thus, the three pass approach of FIG. 5 is exemplary and not limiting to the disclosed embodiments.

If after the final pass, the inventory search process does not identify a new supplier who can provide the requested distressed inventory (e.g., no limousine companies have available vehicles to pick up the consumer at the requested time and/or location), distressed inventory system 110 may generate and send rebooking options to client 130 for display to the consumer (step 545). For instance, the rebooking options may include information notifying the consumer that there are no available suppliers to provide the requested distressed inventory and the option of opening up the consumer's request to other suppliers, such as non-allocated suppliers. The process then continues to FIG. 7.

On the other hand, if during any pass, the distressed inventory search process identifies a new supplier that can provided the requested distressed inventory (steps 520, 530, or 540; Yes), distressed inventory system 110 may perform the reservation booking process to attempt to reserve the requested inventory from the identified supplier (Step 550). The process then returns to step 505 to determine whether the booking was successful.

As shown in FIG. 6, if distressed inventory system 110 successfully books the reservation with the identified supplier (step 505; Yes), the system generates and provides a confirmation message to client 130 for display to the consumer (step 605). The confirmation message may be sent via email, a Web page, text message, telephone, automated voice messaging, or any other form of communication that enables the message to reach client 130. Also, distressed inventory system 110 notifies the supplier of the successful booking using similar communication mechanisms (e.g., email, Web page, text message, automated voice messaging, telephone, etc.) (step 610). In one embodiment, distressed inventory system 110 may request confirmation of the process by which the inventory will be provided to the consumer (step 615). If the supplier confirms the process (step 620; Yes), the process ends at step 630. However, if the supplier does not confirm the process (step 620; No), distressed inventory system 110 performs an agent rebooking process (step 625). For example, distressed inventory system 110 may generate a message including the consumer's request for distressed inventory and provides the message to another system, business entity, or agent that will handle the consumer's request (e.g. travel agent contacts the consumer to arrange alternate form of travel similar to that requested to distressed inventory system 110.) In one embodiment, a user of distressed inventory system 110 may perform one or more processes that allow a user (e.g., an agent) to provide services to the consumer during the agent rebooking process. For example, a customer service team associated with distressed inventory system 110 may be tasked with handling rebooking requests from consumers that experience problems in receiving supplier confirmations for distressed inventory.

FIG. 7 shows processes performed by distressed inventory system 110 when the distressed inventory search process described above in connection with FIG. 3 cannot identify a supplier that can provide the inventory requested by the consumer. See e.g., step 350. In one embodiment, distressed inventory system 110 may then provide another option to the consumer to request distressed inventory by publishing their request to allocated and non-allocated suppliers. For example, distressed inventory system 110 may provide the consumer's request to suppliers that are not registered with distressed inventory system 110 or who are not marketing distressed inventory through distressed inventory system 110, such as, for example, limousine companies who are not included in an allocation list considered by distressed inventory system 110, but are able to pick up an airline passenger consumer from an airport. In one embodiment, a trip provided by this type of supplier may not be offered at a discounted price, as opposed to distressed inventory booked with an allocated supplier registered with the distressed inventory system 110. For instance, distressed inventory system 110 may verify with the consumer via client 130 the information included in the consumer's request (step 705). Distressed inventory system 110 may then collect the segment data from the consumer that may include a broader range of options by the consumer (step 710). For example, in one embodiment, a consumer may provide options related to the requirements included in the request for distressed inventory. For instance, a consumer requesting limousine services may provide segment data including, but not limited to, how long the consumer will wait for delivery/pickup of requested distressed inventory (i.e., “I can wait one hour for a pickup, I need immediate pick up, etc.), alternative destinations (e.g., I can also be dropped off at alternate location XYZ). By providing segment data with one or more consumer options, the consumer improves the chances that the consumer will be serviced or have more options for distressed inventory.

Based on the collected segment data, distressed inventory system 110 may generate a new contract with terms and conditions for receiving the requested inventory (e.g., a ride from the airport) (step 715). Based on the request, distressed inventory system 110 may generate and provide pricing and payment options to the consumer via client 130 (step 725). Distressed inventory system 110 may then request and receive payment from the consumer (step 730). In one embodiment, distressed inventory system 110 may collect payment from the consumer electronically or by other known payment mechanisms (e.g., remote credit card transaction, etc.). Alternatively, or additionally, distressed inventory system 110 may use a previously configured account for the consumer to obtain payment. Further, distressed inventory system 110 may apply any previous payments made by the consumer for undelivered inventory to the newly requested payment.

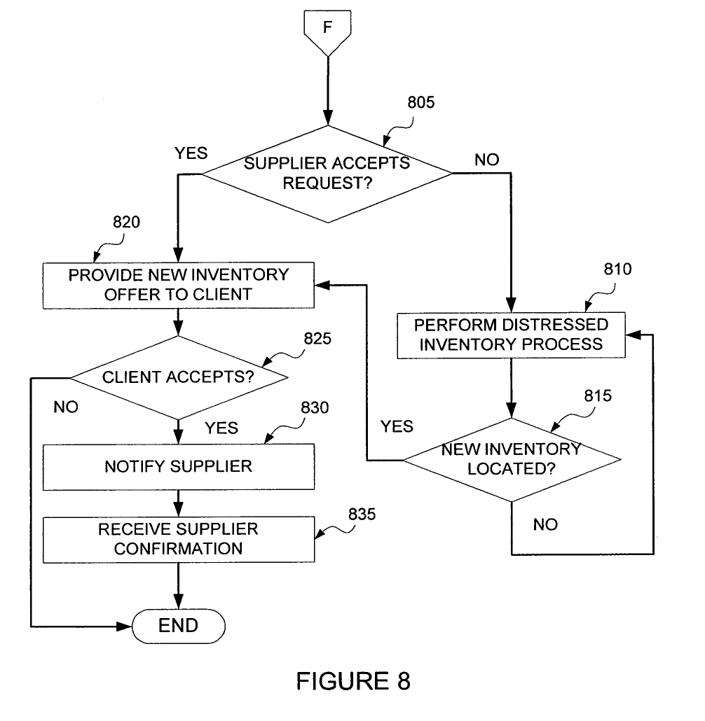

Once payment is received, distressed inventory system 110 may store the contract terms and conditions, along with any registration information related to the consumer's request in memory (step 730). Distressed inventory system 110 may then generate and provide information regarding the consumer's request to a set of suppliers (step 740). In one embodiment, distressed inventory system 110 may publish the consumer's request to a message board via the Internet that is accessible by suppliers 120. Alternatively, distressed inventory system 110 may send messages directly to allocated and/or registered suppliers (e.g., suppliers that registered with distressed inventory system 110) and publish the consumer's request to a Web page or online message board accessible by at least non-allocated or non-registered suppliers. The process then continues to FIG. 8 (step 745).

As shown in FIG. 8, distressed inventory system 110 determines whether any supplier has accepted the published request (step 805). In one embodiment, a supplier 120 may notify distressed inventory system 110 of its acceptance through a Web site associated with system 110. Alternatively, supplier 120 may notify distressed inventory system 110 using other communication mechanisms, such as email, telephone, text messaging, etc. If distressed inventory system 110 does not receive an acceptance from any supplier (Step 805; No), system 110 may re-execute the multiple pass distressed inventory process in a manner similar to that disclosed above in connection with steps 310-335 of FIG. 3 and/or steps 515-540 of FIG. 5 (step 810). Distressed inventory system 110 may repeat the multiple pass inventory process performed in step 810 if no new inventory is located during previous executions of the inventory search process (step 815; No). However, if new inventory is located (step 815; Yes), or a supplier accepts the consumer's request (step 805; Yes), distressed inventory system 110 may generate and provide a new inventory offer to the consumer via client 130 (step 820). In one embodiment, distressed inventory system 110 may provide the offer to the consumer via a Web page that is displayed by browser software executing by client 130. Alternatively, the offer may be provided via email, telephone, facsimile, or any other means of communicating information.

The new inventory offer may include a proposal to provide inventory that does or does not meet every requirement requested by the consumer. For example, the new inventory offer may include variations to the requirements requested by the consumer, such as a different type of vehicle, a different pick up time, different pick up location, etc. The consumer may respond to the new offer by generating and providing a response to distressed inventory system 110 via client 130. The consumer may respond by providing information via Web site associated with distressed inventory system 110, sending an email, sending a text message, etc. If the client does not accept the new offer (step 825; No), the process ends. However, if the client accepts the new offer (step 825; Yes), distressed inventory system 110 generates a message and notifies the identified supplier 120 of the consumer's acceptance (Step 830). In turn, the new supplier 120 may send a confirmation to distressed inventory system 110 that it will provide the requested inventory for the consumer (step 835). Once the confirmation is received, the process ends.

FIG. 9 shows a flowchart of an exemplary distressed inventory search process that may be performed by distressed inventory system 110 consistent with the disclosed embodiments. The inventory search process of FIG. 9 is described in connection with an example of transportation services, such as limousine trip inventory. However, the processes performed in connection with FIG. 9 may be applicable to other types of inventory and industries, and embodiments of the present invention are not limited to the examples described below.

In one embodiment, the distressed inventory search process may allow a consumer to search for distressed inventory based on search parameters, such as airport name, points of interest, city name, destination address, etc. The distressed inventory search process may apply these search parameters and any consumer personal preferences provided during consumer registration to an inventory data structure (e.g., data grid, table, link list, etc.) to locate a match for the consumer's request. For example, if a consumer requests to reserve a limousine to pick them up at airport A at 2 pm, the distressed inventory search process may search the inventory data structure for available limousines that can pick up passengers at Airport A at the same requested time. If no direct match is found, the search process may query the data structure for limousines available near Airport A and are available around 2 pm (e.g., within a certain determined period of time, such as fifteen minutes, thirty minutes, ten minutes, etc.). If one or more matches are identified, the inventory search process may generate a notification for transmission to client 130 by distressed inventory system 110. Moreover, in one embodiment, the inventory search process may be configured to query other processes, such as an allocation process.

In one embodiment, the distressed inventory search process may be begin by receiving input from the consumer via client 130 and distressed inventory system 110 (Step 905). The input may include search terms that the consumer provides for locating distressed inventory (E.g., location, pickup times, flight information, etc.). The inventory search process determines the type of request that the consumer provided (step 910), such as, for example, an airport trip or an event trip. In one embodiment, an airport trip may be governed by flight times, while an event trip may be governed by the consumer. For example, a limousine company may have less flexibility to provide distressed inventory to consumers who require a pickup from an airport due to fixed rules that govern the limousine company for trips to the airport. Conversely, a supplying limousine company may have more options to offer a consumer who requests pickup and dropoff from other types of locations. Accordingly, certain embodiments of the present invention provide processes to handle both scenarios.

For instance, in one embodiment, if the trip type requested by the consumer is related to an airport pickup or destination, the inventory search process performs an airport to zone search (step 915). An airport to zone search may be a processes performed when a request is associated with a consumer request for travel from an airport to a particular destination, such as a location within a predetermined taxi fare zone. For instance, a region may have fixed taxi fare zones (e.g., fixed cost for travel from zone 1 to zone 3) to ensure drivers don't take advantage of consumers. Certain embodiments of the disclosed invention may use applicable zone information to calculate the fee The distressed inventory search process may then set one or more parameters for one or more end points in the requested trip (step 920). In one embodiment, setting one or more parameters for one or more end points may provide distressed inventory system 110 the option to use multiple means to calculate a rate for charging the consumer. This process may allow the distressed inventory search process to take into consideration that supplier services in different geographical areas may be governed by different rules (e.g. taxi zones are different in New York City are different than those in Naples, Fla.). Accordingly, in one embodiment, distressed inventory system 110 may collect information related to a local area associated with the consumer, system 110, supplier 120, client 130, and/or any other entity or component related to aspects of the present invention to use available information regarding local practices, fees, zones, etc., thus enabling the processes to provide single or multiple approaches for marketing distressed inventory. For instance, distressed inventory system 110 may execute multiple processes concurrently that each consider a different aspect of local information, such as a first process setting parameters based on local zone rules and a second process setting parameters based on other information.

The inventory search process may also determine one or more time adders for the request by the consumer (step 925). A time adder may be a value that represents an amount of time added to an estimated pickup time value due to certain conditions, such as weather, time of day, day of the week, day of the year (e.g., holiday), local events, etc. For example, the distressed inventory search process may add time to an estimated pickup or delivery time based on whether a local sports team is playing in town during or near the requested time of travel from the consumer. For instance, the estimated time for a limousine company to deliver a consumer to LaGuardia airport in New York City may increase if the New York Mets baseball team is hosting a baseball game near the same time as the requested travel (e.g., extra traffic from the north of New York City may be flowing in toward LaGuardia and JFK airports).

The inventory search process may also determine one or more pick up and/or drop off windows for the requested inventory (step 930). In one aspect, setting up a pick up and/or drop off windows may entail determining and setting an interval of time related to the consumer's requested pick up or drop off time. For instance, a pick up window may be a determine range of time (e.g., within ten minutes of requested pick up time) or may be set times (e.g., 1:50 pm to 2:10 pm for a requested 2 pm pick up time). Other forms of intervals may be implemented by certain embodiments of the present invention.

Once the inventory search process has configured the attributes for the inventory search (e.g., parameters, time adders, time windows, etc.), the process may search a determined list of suppliers' distressed inventory that are allocated for an airport to zone type of trip (step 935). If no match is found (step 935; No), the inventory search process may generate an indication reflecting the no match for consideration by other processes (step 955), such as the distressed inventory process disclosed above in connection with FIGS. 3-8. See e.g., step 315, 325, 335 of FIG. 3 and steps 520, 530, 540 of FIG. 5. However, if one or more suppliers are identified that have available distressed inventory that matches the needs of the consumer (step 935; Yes), the inventory search process may generate an indication of a relationship between the identified suppliers and the needs of the consumer by at least the duration and airport time (step 940). The inventory search process then prepare the results of the match or matches that have been identified (step 945), and provides the results to an allocation process to determine a supplier to provide distressed inventory to the consumer (step 950).

Referring back to step 910, if a consumer's request identifies an event type of trip (step 910; Event), the inventory search process prepares to perform a zone to zone search (step 960). To do so, the process may select regional zones (step 965). In one embodiment, selecting regional zones may include searching, collecting, and analyzing local zone rules and information to determine travel requirements for the requested distressed inventory. For instance, based on the consumer's request, distressed inventory system 110 may perform a process that determines what zones are applicable for the locality related to the consumer's request. In one embodiment, the distressed inventory search process may skip selecting regional zones if not applicable (e.g., a locality does not implement a zone fare system or protocol). Further, the inventory search process may determine time adders for the route to the requested destination, such day of the week, time of day, is the day a holiday, etc. (step 970). The time adders are used to adjust the expected pick up time for the consumer based on outside influences, such as rush hour traffic, weather conditions (e.g., winter), weekend traffic v. work week traffic, etc.). The inventory search process may also determine one or more pick up and/or drop off windows for the requested inventory (step 975).

Once the inventory search process has configured the attributes for the inventory search (e.g., parameters, time adders, time windows, etc.), the process may search a determined list of suppliers' distressed inventory that are allocated for a zone to zone type of trip (step 980). If no match is found (step 980; No), the inventory search process may generate an indication reflecting the no match (step 955) for consideration by other processes, such as the distressed inventory process disclosed above in connection with FIGS. 3-8. See e.g., step 315, 325, 335 of FIG. 3 and steps 520, 530, 540 of FIG. 5. However, if one or more suppliers are identified that have available distressed inventory that matches the needs of the consumer (step 980; Yes), the inventory search process may generate an indication of a match by at least the duration, required time, and a consumer's provided acceptable wait period (step 985). The inventory search process then prepare the results of the match or matches that have been identified (step 945), and provides the results to an allocation process (step 950).

Accordingly, certain embodiment of the present invention allow distressed inventory system 110 to perform certain search processes based on the type of trip requested by the consumer. For instance, in one aspect, a zone-to-zone search process may differ from an airport-to-zone search process based on a flight time parameter that may be used exclusively for airport-to-zone or zone-to-airport trip types. Also, the zone-to-zone search process may differ from an airport-to-zone search process based on a requested time parameter and a wait time parameter for the zone-to-zone search, which in one embodiment, may be applied only to zone-to-zone trip types because there may be no fixed flight time to support.

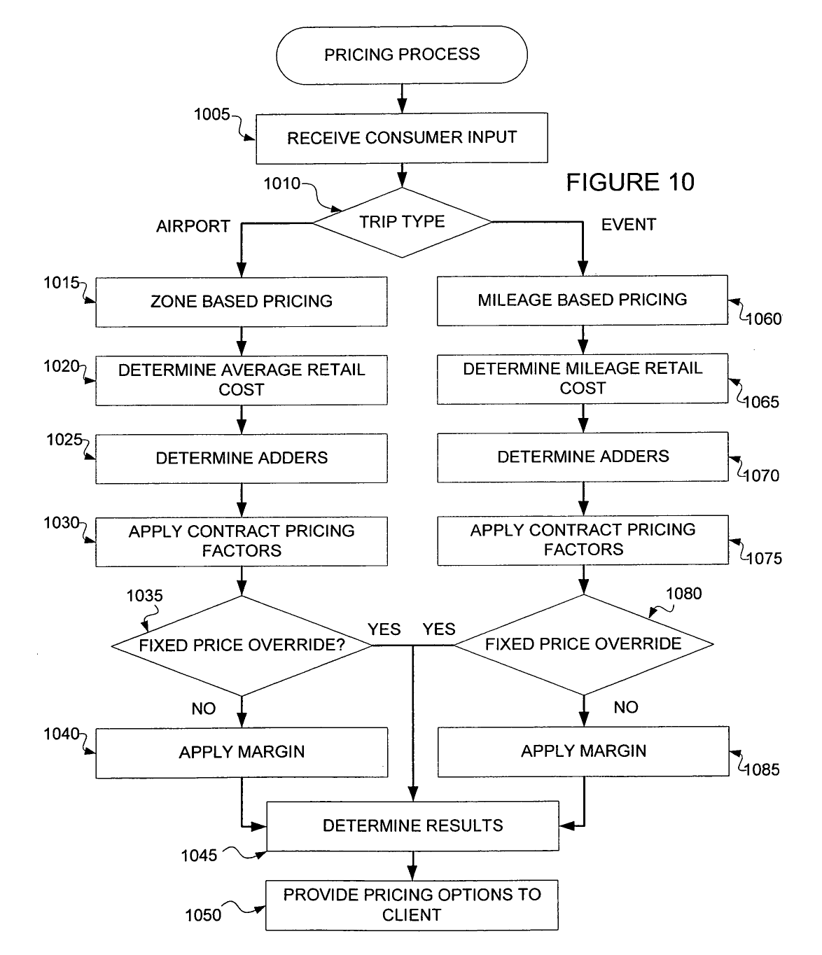

FIG. 10 shows a flowchart of an exemplary pricing process consistent with certain embodiments of the present invention. The pricing process of FIG. 10 is described in connection with an example of transportation services, such as limousine trip inventory. The processes performed in connection with FIG. 10 may be applicable to other types of inventory and industries, and embodiments of the present invention are not limited to the examples described below.

The pricing process determines fixed and/or discounted prices for distressed inventory based on different factors, such as type of vehicle, distance to destination, travel zone, average retail price for the travel zone, value of the load, type of load, etc. In one embodiment, distressed inventory system 110 may generate data reflecting a travel zone, which may include a start zone and a destination zone. The start zone may represent the pickup location (e.g., Shelton, Conn.) and the destination zone may represent the destination location (e.g., Washington D.C.). Thus, the travel zone represents the trip between the start and destination zone (e.g., travel zone is Shelton, Conn. to Washington D.C.) and may include or reference all parameters that apply to that trip In one embodiment, the pricing process determines the price(s) for available distressed inventory for a consumer and generates data for display by client 130. For example, the pricing process may generate data that only displays the cost for a respective distressed inventory and the type of inventory (e.g., type of vehicle) without providing the identification of the supplier 120, prior to the consumer selecting a particular distressed inventory. Other processes and pricing algorithms may be implemented consistent with certain embodiments of the invention.

As shown in FIG. 10, the pricing process may receive the type of distressed inventory the consumer is requesting (step 1005). In one embodiment, based on the trip type (e.g., airport or event) associated with the consumer's input (step 1010), the pricing process may perform a zone based pricing process (step 1015) or a mileage based pricing process (step 1060). If the consumer requests an airport type trip (step 1010; “airport”), the pricing process performs zone based pricing (step 1015) by determining an average retail cost for the regional zone associated with the consumer's request (Step 1020). In one embodiment, the pricing process may determine a retail price of a distressed inventory (e.g., requested travel) based on information related to the locality and geographic aspects of the inventory. For instance, the pricing process may calculate a retail price based on zone to zone pricing information, mileage of a trip zone, temporal information, etc. Moreover, in one embodiment, the pricing process may calculate a discounted process based on the retail price. The pricing process may then determine adders that adjust the price of the inventory requested by the consumer based on different factors, such as day of the week, time of day, holiday schedule, seasonal information, etc. (step 1025).

In step 1030, the pricing process may apply contract pricing factors that adjusts the zone based priced determined in step 1025. In one embodiment, contract pricing may represent special pricing for a certain distressed inventory that overrides calculated pricing for the same inventory. For example, the pricing process may determine contract pricing based on a trip zone that overrides or changes a calculated price for a requested trip (e.g. $10 off all trips from airport A this week) The pricing process may also determine whether a fixed price override condition exists (step 1035). A fixed price override condition may be a special pricing that overrides calculated pricing based on certain condition(s). For example, a fixed price override may include a fixed price for all trips from a determined first and/or determined second location (e.g., all trips to JFK airport trips from Bridgeport, Conn. are $100 for a certain amount of time, such as one week). If there is no fixed price override (step 1035; No), the pricing process applies a margin (step 1040), generates one or more pricing options for the consumer (step 1045) and provides the pricing option to client 130 for presentation to the consumer (step 1050). On the other hand, if a fixed price override does exist (step 1035; Yes), the process continues to steps 1045 and 1050, as explained above.

If the consumer requests an event trip type (step 1010; event), the pricing process performs mileage based pricing process (step 1060). In one embodiment, the mileage based pricing process may determine retail cost of the requested trip based on an estimated or determined mileage for delivering the consumer to the requested destination (step 1065). The pricing process may then determine adders that adjust the mileage price based on different factors, such as day of the week, time of day, holiday schedule, seasonal information, etc. (step 1070). In step 1075, the pricing process may apply contract pricing factors to adjust the price of the requested inventory. In one embodiment, this contract pricing may represent special pricing for a certain distressed inventory that overrides calculated pricing for the same inventory and applied to zone-to-zone trips or events. The pricing process may also determine whether a fixed price override condition exists (step 1080). If there is no fixed price override (step 1080; No), the pricing process applies a margin (step 1085), generates one or more pricing options for the consumer (step 1045) and provides the pricing option to client 130 for presentation to the consumer (step 1050).

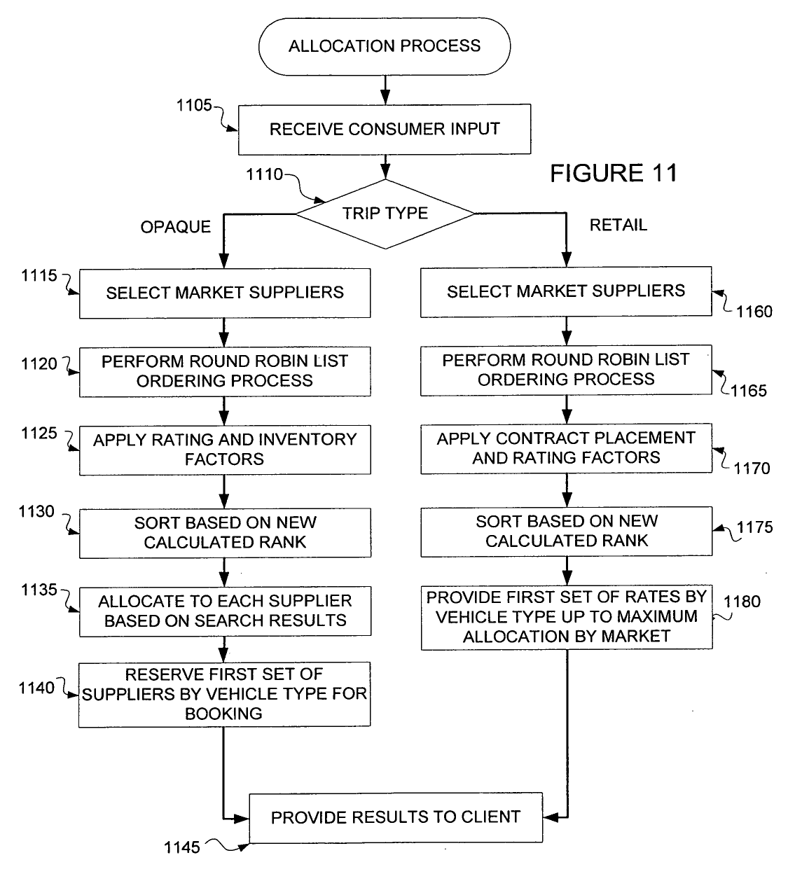

FIG. 11 shows a flowchart of an allocation process that may be performed by distressed inventory system 110 consistent with the disclosed embodiments. The allocation process determines a list of suppliers eligible for consideration for providing distressed inventory to the consumer. The allocation process levels the playing field for participating suppliers 120 by considering one or more factors to determine what suppliers are assigned to the list, and what suppliers are considered before others when presenting their available inventory to the consumer. For example, the allocation process may consider last booking date, amount of inventory posted, customer ratings to determine which suppliers are given business opportunities and when. Further, the allocation process may be configured to penalize suppliers that have been reported to give inadequate service, or have failed to meet certain criteria set by distressed inventory system 110.

As shown in FIG. 11, the allocation process receives input from the consumer via client 130 regarding the type of distressed inventory requested by the consumer (step 1105). The allocation process determines in step 1110 the type of inventory requested, such as an opaque or retail trip type. In one embodiment, to process an opaque trip, distressed inventory system 110 may perform ranking and allocation processes based on one or more factors, such as last booking date, amount of inventory posted, customer ratings, etc. and provides the consumer a choice of available inventory. In one aspect, distressed inventory 110 does not provide the identity of the supplier 120 until the consumer accepts a reservation. In another embodiment, processing a retail type trip may include performing ranking and allocation processes that consider one or more of the previously mentioned factors. However, in a retail trip process, distressed inventory system 110 may provide the consumer with one or more choices of distressed inventory along with other information, such as characteristic data related to the suppliers 120 (e.g., information reflecting why one limousine company is ranked higher than other companies, etc.). Distressed inventory system 110 may provide through client 130 the supplier ranking criteria and the identity of the supplier 120 to enable the consumer to select the distressed inventory and supplier 120, as opposed to distressed inventory system 110 automatically selecting a supplier for the consumer.

If an opaque trip type is requested (step 1110, opaque), the allocation process selects a set of market suppliers for consideration and marketing by distressed inventory system 110 (step 1115). The allocation process may then perform a round robin list ordering process that ranks the suppliers in the list in round robin fashion (step 1120). In step 1125, the allocation process determines or retrieves any rating and inventory factors associated with each supplier in the ranked set of suppliers (step 1125). For example, distressed inventory system 110 may execute one or more processes that apply one or more rating values to each supplier that registers with system 110. The rating values may include a customer service rating related to feedback from previous consumers of an associated supplier, a peer rating related to feedback from other suppliers in the same industry, a rating assigned by distressed inventory system 110 that is assigned based on previous payment, delivery, or other performances, or any other type of rating that may be assigned to each supplier for a given topic. In another embodiment, the rating values may also include inventory ratings that related to a last booking date for each supplier. Thus, if a supplier has booked a distressed inventory contract within a determined time period, distressed inventory system 110 may assign a rating value that lowers the rank of that supplier being included in the list of suppliers provided to consumer for a current distressed inventory request. Further, the rating value may include a rating associated with the amount of distressed inventory posted by each supplier.

Thus, distressed inventory system 110 may lower the allocation rank of a supplier who has posted ten inventory opportunities with distressed inventory system 110 relative to an allocation rank of another supplier who has only posted one opportunity. Moreover, distressed inventory system 110 may assigned a rating value for poor performance on previous distressed inventory deliveries. Thus, a supplier who was late in delivering a consumer to a requested destination may receive a rating value that lowers the rank of that supplier for consideration in the allocation list for the current consumer's request. It should be noted that the above listed ratings are exemplary and embodiments of the present invention may assign, maintain, and use other types of ratings when determining an allocation rank for a supplier of distressed inventory.

Based on the ratings of each supplier in the allocation list, the allocation process ranks the suppliers in the set of suppliers such that suppliers with more favorable rankings are to be considered before other suppliers with lower rankings (step 1130). Once the allocation list of suppliers is sorted, the allocation process may allocate requested distressed inventory to respective suppliers based on the consumer's search results determined in the search process described above in connection with FIG. 9 (step 1135). Thus, a supplier who has been ranked higher than other suppliers, and is one of the suppliers included in the search results processed in FIG. 9, may be allocated to a consumer's request before other lower ranked suppliers. The allocation process may then perform processes for reserving the first set of allocated suppliers included in the allocation list based on features of their distressed inventory, such as vehicle type (step 1140). The allocation process than provides the results of the allocation process to the consumer via client 130 (step 1145).

Returning back to step 1110, if the trip type requested by the consumer is a retail trip type, the allocation process selects a set of market suppliers for consideration and marketing by distressed inventory system 110 (step 1160). The allocation process may then perform a round robin list ordering process that ranks the suppliers in the list in round robin fashion (step 1165). In step 1125, the allocation process applies contract placement and/or rating factors to each supplier in the list. For example, a supplier 120 may arrange contract terms (e.g., better pricing, more cars available, etc.) with distressed inventory system 110 (or an entity associated with system 110) that gives that supplier a potential advantage for securing business through the medium used by distressed inventory system 110 for marketing distressed inventory, such as a Web site.

Based on the ratings of each supplier in the allocation list, the allocation process ranks the suppliers in the set of suppliers such that suppliers with more favorable rankings are to be considered before other suppliers with lower rankings (step 1175). The allocation process may then provide a first set of rates based on vehicle type up to a maximum allocation based on the market (step 1180). Once the factors are measured, and the suppliers 120 are ranked to identify the set of suppliers 120 that best fit the request, the results are provided to the consumer via client 130 (step 1145).

As disclosed, the disclosed embodiments provide a system and methods for offering consumers a view of available distressed inventory, such as unused segments for transportation and logistics services. Consumers may have real time access to the distressed inventory via the Internet or other networking environments. Accordingly, for example, a consumer may use embodiments of the present invention to review and select online via the Internet, a limousine ride from an airport after arrival. Also, the limousine company may use embodiments of the present invention to market and sell its unused trip segments to potential consumers in the vicinity of its distressed inventory (e.g., empty limousine after dropping off a passenger). For example, in one embodiment, a consumer of limousine services may input ride requirements via a Web site and may instantly see ride options that match their reservation requirements (e.g., date, time, type of car, number of passengers). If distressed inventory system 110 determines that an active inventory of unused segments from limousines are available, system 110 may publish the available inventory to the consumer via the Web site to enable the consumer immediately reserve a selected limousine. On the other hand, if distressed inventory system does not identify a match for the consumer, it may post the consumer's reservation requirements to the Web site and notify a network of partnered limousine companies that a consumer request is pending in system 110. Once a match is found, distressed inventory system may notify the consumer via the Web site, email, or other communication means, that a match to their reservation requirements have become available. In one embodiment, if an email is provided to the consumer, the consumer may later return to the Web site and accept the match with a financial account, such as a credit card, a debit card, or the like.

Further, methods and systems consistent with the present invention allow registered limousine companies to input their unused segments into the Web site months, weeks, days or even minutes before the unused segment(s) become available. Once a consumer accepts a reservation, distressed inventory system 110 may notify the limousine company and provide the limousine company with the contact information for the consumer, and the consumer with the contact information for the limousine company. Thus, the limousine company may contact the consumer directly to confirm the details of the reservation.

Thus, the disclosed embodiments provide at least the following exemplary features for suppliers of distressed inventory:
1. Online registration, including, but not limited to, contracting of business terms and conditions directly from a Web site. Suppliers may also communicate with a representative of distressed inventory system 110 via telephone or cell phone (e.g., 1-800 number).
2. Provision of data that allows supplier 120 to execute a Web-browser based user interface that enables supplier 120 to input and manage distressed inventory (e.g., unused segments). The data may include data or applications software that enables the supplier 120 interface to view, edit, post, or remove, distressed inventory of itself and/or other suppliers on an online grid and/or form in a user-friendly manner.
3. Standard, fixed, and discounted pricing for a supplier's distressed inventory based on different factors, such as vehicle type, zone, miles to destination, etc.
4. Automated allocation of suppliers based on different factors, including but not limited to, the amount of inventory provided, percentage of previous bookings contracted, consumer ratings, etc. This provides a mechanism that allows fair allocation of a supplier's distressed inventory for consideration by consumers.
5. Online marketing via one or more processes (e.g., search engine optimization, affiliates, etc.) to enable supplier 120 to market its distressed inventory for sale over the Internet or other mediums, including but not limited to, mobile networks telephone,. facsimile, text services, etc.
6. Creating and notifying binding sales contracts between the supplier 120 and a consumer and providing a mechanism for displaying documents related to the contracts.
7. Payment to supplier 120 upon completing service to a consumer.
8. Cancellation policies and/or fines for suppliers who remove an empty segment from an online inventory grid of available distressed inventory from suppliers.

Further, the disclosed embodiments provide at least the following exemplary features for consumers of distressed inventory:
1. Online registration, including, but not limited to, contracting of privacy and business terms and conditions directly from a Web site. Consumers may also communicate with a representative of distressed inventory system 110 via telephone or cell phone (e.g., 1-800 number).
2. Provision of data and/or software applications that allows client 130 to provide information via a Web-browser based user interface for allowing a consumer to input distressed inventory requirements, such as date, pickup time, location, vehicle preference, travel carrier information (e.g., flight data, etc.) etc.
3. Provision of data and or software applications that allows client 130 to provide information via an online, Web browser based user interface for allowing a consumer to search for distressed inventory. In one embodiment, the interface may provide an aggregated view of available empty segments for sale from suppliers based on the requirements entered by a supplier, such as requested dates of service, location, preferred vehicle or transportation method.
4. Notifications and the ability for client 130 to display data reflecting distressed inventory, available discount inventory that a consumer may reserve, and/or confirmed requested distressed inventory for a fixed price through electronic mediums (e.g., open request board, direct contact with suppliers, etc.)
5. Provision of a mechanism to enable a consumer to provide all necessary information and documentation to create a binding sales contract with supplier 120 and/or a business entity related to distressed inventor system 110.
6. Provision of mechanisms to facilitate the provision of distressed inventory to consumers, such as maintaining contact with a supplier to ensure transportation or logistic services is provided as requested by a consumer.
7. Provision of mechanisms to enable consumers to display contract terms and conditions for reproduction and for the electronic execution of agreed contracts (e.g., electronic signature). Moreover, embodiments of the present invention enable the creation and notification of binding sales contracts between the supplier and consumer(s) and providing a mechanism for displaying documents related to the contracts.
8. Providing contact information of a supplier providing selected distressed inventory.
9. Provision of a mechanism to collect payment for selected distressed inventory from a consumer for reserving and receiving distressed inventory from supplier 120.

The disclosed embodiments may be implemented using various components and used for many different types of applications. Other embodiments of the invention will be apparent to those skilled in the art from consideration of the specification and practice of the disclosed embodiments. For example, methods and systems consistent with the disclosed embodiments may be applied to the livery service to allow consumers requesting rides from limousine services to search, view, select, and receive a ride from an empty limousine marketed by a limousine company. However, methods and systems consistent with the disclosed embodiments are applicable in other industries. For instance, the distressed inventory may include inventory from transportation services, logistics services, courier services, etc. For instance a courier service that delivers packages, including but not limited to bicycle couriers, parcel couriers, etc., may market their unused segments (e.g., trip segments that exists following delivery of a parcel) using distressed inventory system 110.

As another example, a trucking service or driver may post available space on one or more of its vehicles during, following, or prior to, dropping off an existing load. For instance, consider a driver operating, or a trucking organization for, a truck leaving San Francisco and scheduled to deliver loads to Denver and New York City on certain respective dates. The driver or trucking organization may use a Web site provided by distressed inventory system 110 to post available space on the truck after, or prior, to unloading cargo in Denver. Through, for example, the Web site provided by distressed inventory system 110, a consumer in Denver may search for available space on a truck that may deliver cargo that needs to be sent to New York City. Distressed inventory system 110 may perform processes to match the consumer and the truck's unused segment (e.g., empty space on the truck) to enable the consumer's cargo to be delivered to New York City by the truck.

Alternatively, consumers may use the distressed inventory processes to provide delivery of inventory or individuals in a manner similar to that disclosed above (e.g., a user in Denver may request a ride to New York City, and a driver passing through Denver may market available space in a vehicle headed to New York City.

In another embodiment, distressed inventory system 110 may provide a negotiation environment for suppliers 120 to bid and/or negotiate for providing distressed inventory to client 130. For instance, in one aspect, distressed inventory system 110 may perform one or more processes that, when executed by a processor, allow suppliers 120 to present bids for their available inventory to client 130 in an online auction or bidding process. Client 130 may present the bids to the consumer via, for example, a Web browser, and provide a mechanism for the consumer to select a winning supplier 120. Alternatively, distressed inventory system may provide a mechanism for supplier 120 to negotiate directly with a consumer associated with client 130 via a Web site, or other medium. For example, distressed inventory system may execute one or more processes that initiate a negotiation process through a Web site after the consumer selects an available distressed inventory. Other mechanisms may be implemented for providing bidding or negotiations between suppliers 120 and client 130 consistent with certain aspects of the disclosed embodiments.

Moreover, the processes described in FIGS. 2-11 are exemplary and are not intended to be limiting to the disclosed embodiments. The sequence of steps or types of functions of one or more of the processes disclosed in FIGS. 2-11 may vary or be removed, and additional processes may be added.

It is intended that the specification and examples be considered as exemplary only, with a true scope and spirit of the invention being indicated by the following claims.

What is claimed is:

1. A method for marketing distressed inventory, the method performed by a distressed inventory system comprising:
receiving distressed inventory data from at least one supplier reflecting available distressed inventory;
receiving a request from a client;
determining a relationship between the request and the available distressed inventory;
notifying the client of the available distressed inventory;
receiving an indication that the client has accepted one or more terms for receiving the available distressed inventory; and
reserving the available distressed inventory for the client.

2. The method of claim 1, wherein determining a relationship between the request and the available distressed inventory includes:
searching a list of allocated suppliers to identify one or more suppliers that have available distressed inventory that matches requirements included in the consumer's request for inventory.

3. The method of claim 1, wherein determining a relationship between the request and the available distressed inventory includes:
reordering a first list of suppliers of distressed inventory to create a second list of suppliers, wherein the first list includes the at least one supplier;
for each supplier in the second list of suppliers:
applying a rating value to the respective supplier based one at least on factor associated with the supplier;
reordering the second list of suppliers based on each supplier's rating value to create a third list of suppliers;
allocating the at least one supplier from the second list of suppliers to provide distressed inventory to the client based on the request and the rating value of the at least one supplier.

4. The method of claim 1, wherein receiving the request from the client includes:
setting parameters for the request based on requirements included in the request;
determining time adders to the request;
setting a window of time for at least one of a pick up time or delivery time of the requested inventory;
determining a relationship between the request and the available distressed inventory based on a location of the available distressed inventory in relation to a location of a consumer associated with the client; and
determining a relationship between the request and the available distressed inventory based on a duration of time the distressed inventory is available and an estimated time of arrival of the consumer at a pick up location.

5. The method of claim 4, wherein determining time adders to the request is based on at least one of the day of the week for the requested inventory, the time of day for delivery of the requested inventory, and whether the day of delivery for the requested inventory is a holiday.

6. The method of claim 1, wherein receiving an indication that the client has accepted one or more terms for receiving the available distressed inventory includes:
determining pricing options for the client to receive the distressed inventory based on a first fixed price value or a second price value based on characteristics associated with the requested inventory.

7. The method of claim 6, wherein determining pricing options includes:
determining an average retail cost value for delivering the requested inventory based on a set of supplier's rates for delivering similar inventory with similar delivery parameters; and determining the second price value by adjusting the average retail cost value based on at least one of a time of day, day of the week, and a day of the year.

8. The method of claim 1, further including:
providing a Web site, and wherein the receiving distressed inventory data from at least one supplier includes receiving the distressed inventory data via the Web site, and wherein receiving a request for inventory from a client includes receiving the request via the Web site.

9. The method of claim 1, wherein the distressed inventory is a unused segment of a transportation or logistics service, the supplier is a transportation or logistics supplier, and the requested inventory is one of travel from an originating location to a destination location or a product that is to be delivered from an originating delivery location to a delivery destination location.

10. The method of claim 1, wherein receiving an indication that the client has accepted one or more terms for receiving the available distressed inventory includes:
requesting payment from the client for the requested inventory based on the matched distressed inventory; and
receiving the payment from the client prior to the client receiving the distressed inventory.

11. A distressed inventory system, comprising:
a computer system; and
at least one memory including software processes executed by the computer system, the software processes configured to perform, when executed by the computer system:
receive distressed inventory data from at least one supplier reflecting available distressed inventory;
receive a request from a client;
determine a relationship between the request and the available distressed inventory;
notify the client of the available distressed inventory;
receive an indication that the client has accepted an agreement to receive the available distressed inventory in exchange for payment of funds; and
reserve the available distressed inventory for the client after receiving payment and before a consumer associated with the client receives the available distressed inventory.

12. The distressed inventory system of claim 11, wherein the software processes are configured to, when executed by the computer system, search a list of allocated suppliers to identify one or more suppliers that have available distressed inventory that match one or more requirements included in the client's request for inventory.

13. The distressed inventory system of claim 11, wherein the software processes are configured to, when executed by the computer system:
reorder a first list of suppliers of distressed inventory to create a second list of suppliers, wherein the first list includes the at least one supplier;
apply, for each supplier in the second list of suppliers, a rating value to the respective supplier based one at least on factor associated with the supplier;
apply a rating value to the respective supplier based one at least on factor associated with the supplier;
reorder the second list of suppliers based on each supplier's rating value to create a third list of suppliers; and
allocate the at least one supplier from the second list of suppliers to provide distressed inventory to the client based on the request and the rating value of the at least one supplier.

14. The distressed inventory system of claim 11, wherein the software processes are configured to, when executed by the computer system:
set one or more parameters for the request based on requirements included in the request;
determine one or more time adders to the request;
set a window of time for at least one of a pick up time or delivery time of inventory identified in the request;
determine a relationship between the request and the available distressed inventory based on a location of the available distressed inventory in relation to a location of a consumer associated with the client; and
determine a relationship between the request and the available distressed inventory based on a duration of time the distressed inventory is available and an estimated time of arrival of the consumer at a pick up location.

15. The distressed inventory system of claim 14, wherein the one or more time adders are based on at least one of the day of the week for delivery of inventory identified in the request, the time of day for delivery of the requested inventory, and whether the day of delivery for the requested inventory is a holiday.

16. The distressed inventory system of claim 11, wherein the software processes are configured to, when executed by the computer system, determine one or more pricing options for a consumer associated with the client to receive the distressed inventory based on a first fixed price value or a second price value that is based on characteristics associated with inventory identified in the request.

17. The distressed inventory system of claim 16, wherein the software processes are configured to, when executed by the computer system, determine an average retail cost value for delivering the requested inventory based on a set of supplier's rates for delivering similar inventory with similar delivery parameters; and
determine the second price value by adjusting the average retail cost value based on at least one of a time of day, day of the week, and a day of the year.

18. The distressed inventory system of claim 11, wherein the computer system is associated with a Web site, and wherein the software processes are configured to, when executed by the computer system, receive the distressed inventory data via the Web site, and receive the request via the Web site.

19. A system for marketing transportation services, comprising:
a network; and
a computer system connected to the network, configured to:
provide a Web site that presents data representing a set of available unused travel segments, wherein each available unused travel segment is associated with at least one transportation supplier;
receive, via input from a consumer to the Web site, a request for travel from a first location to a first destination;
determine a relationship between the request and at least one of the available unused travel segments based on a comparison of the request and at least one of a characteristic of the available unused travel segments and the transportation supplier;
provide a list of unused travel segments to the Web site including the at least one available unused travel segments;
receive, via input from the consumer to the Web site, a selection of the at least one available unused travel segment;
determine a price for the at least one available unused travel segment;
determine that a first payment of the price has been received; and
provide a second payment to the transportation supplier associated with the selected at least one available unused travel segment, wherein the second payment is less than the first payment.

20. A method for marketing transportation services, comprising:
providing a Web site that includes data reflecting a set of available unused segments of transportation service suppliers;
providing through the Web site, a mechanism for a user to input a request for transportation, wherein the request includes at least one parameter including at least one of a type of vehicle parameter, a number of passengers parameter, a passenger airline flight information parameter, a pick up time parameter, a destination parameter, and a pick up location parameter;
presenting through the Web site a set of available unused segments include at least one parameter that matches the at least one parameter of the request;
receiving through the Web site a selection of a first one of the available unused segments;
receiving payment for the selected first available unused segment;
presenting a confirmation of a reservation for the user to receive the first available unused segment.
